(19) United States
(12) Patent Application Publication
(10) Pub. No.: US 2011/0126760 A1
(43) Pub. Date: Jun. 2, 2011

(54) IMAGING APPARATUS AND METHOD FOR MAKING FLEXOGRAPHIC PRINTING MASTERS

(75) Inventors: Eddie Daems, Herentals (BE); Luc Vanmaele, Lochristi (BE)

(73) Assignee: Agfa Graphics NV, Mortsel (BE)

(21) Appl. No.: 13/055,718

(22) PCT Filed: Aug. 6, 2009
(86) PCT No.: PCT/EP2009/060190

§ 371 Date: Jan. 25, 2011

Related U.S. Application Data
(60) Provisional application No. 61/087,752, filed on Aug. 11, 2008.

(30) Foreign Application Priority Data
Aug. 11, 2008 (EP) 08105011.4

(51) Int. Cl. B05C 11/02; C08J 7/18; B41F 7/02

(52) U.S. Cl. 118/46; 427/510; 101/217

(57) ABSTRACT

A method for making a flexographic printing master includes a first step of providing a flexographic printing support; a second step of applying image wise with a first resolution a layer of a radiation curable liquid partially covering the printing side of the support; a third step of flood exposing the applied radiation curable layer to fully cure the layer; and a fourth step of image wise laser engraving the cured layer with a second resolution which is higher than the resolution of the second step. An imaging apparatus can perform the above method.

### BACKGROUND OF THE INVENTION

1. Field of the Invention

The present invention relates to a method for making a flexographic printing master by laser engraving and an imaging apparatus for performing the method.

2. Description of the Related Art

Flexography is commonly used for high-volume runs of printing on a variety of supports such as paper, paperboard stock, corrugated board, films, foils and laminates. Packaging foils and grocery bags are prominent examples.

Flexographic printing forms are today made by both analogue imaging techniques such as a UV exposure through a mask, e.g. U.S. Pat. No. 6,521,390 (BASF), and digital imaging techniques which includes direct laser engraving on flexographic printing form precursors, e.g. US 2004/0259022 (BASF), and inkjet printing e.g. EP 1428666 A (AGFA) and US 2006/0055761 (AGFA).

Two main types of flexographic printing forms can be distinguished: a sheet form and a continuous cylindrical form. Continuous printing forms provide improved registration accuracy and lower change-over-time on press. Furthermore, such continuous printing forms may be well-suited for mounting on laser exposure equipment, where it can replace the drum, or be mounted on the drum for exposure by laser. Continuous printing forms have applications in the flexographic printing of continuous designs such as in wallpaper, decoration, gift wrapping paper and packaging.

Direct laser engraving has several advantages over the conventional production of flexographic printing masters. A number of time-consuming process steps, such as the creation of a photographic negative mask or development and drying of the printing master, can be dispensed with. Furthermore, the sidewall shape of the individual relief elements can be individually designed in the laser engraving technique. While the sidewalls of a relief dot diverge continuously from the surface to the relief base in the case of photopolymer plates, a sidewall which is perpendicular or virtually perpendicular in the upper region and which does not broaden until the lower region can also be engraved by laser engraving. Thus, there is no, or at any rate little, increase in tonal value even with increasing wear of the plate during the printing process.

The process of direct laser engraving of photopolymer flexo printing forms has many advantages, but also causes some problems due to the impact on the environment as well as on human health. The laser engraving of polymer materials generates a waste air stream containing toxic substances which must be eliminated from the waste air stream. This generated residue must be collected using an enclosed extraction system and sent to incineration or a landfill.

Inkjet printing provides an additive method to prepare a flexographic printing master by jetting subsequent layers of elastic ink upon a substrate using an ink jet printing system. Each layer is immobilised by an immobilisation step before jetting the following layer. A printing relief is gradually formed to obtain a flexographic printing plate allowing accurate control over the relief and slopes of the printing plates. Use can be made of different inks or immobilisation steps to obtain different layer characteristics. Advantages of such a method of preparing a flexographic printing master are the absence of any processing steps and the consumption of no more material as necessary to form a suitable relief image (i.e. removal of non printing areas is no longer required).

However, the access time for obtaining a flexographic printing master is increased by using the inkjet printing method, especially when high resolution flexographic print quality is required.

A need exists for making high quality flexographic printing masters in a safe way at low production cost and with a fast access time.

### SUMMARY OF THE INVENTION

In order to overcome the problems described above, preferred embodiments of the present invention provide a method for making a flexographic printing master as defined below.

A preferred embodiment of the present invention provides an imaging apparatus for performing the above method.

Further advantages of the present invention will become apparent from the description hereinafter.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 shows a flexographic printing master in 1c made from a sprayed layer of radiation curable liquid in 1a.

FIG. 2 shows a flexographic printing master in 2c made from an inkjet printed layer of radiation curable liquid in 2a.

FIG. 3 shows flexographic printing masters having a relief for printing a dot in 3a and having a sharpened relief for printing a smaller dot in 3b.

### DETAILED DESCRIPTION OF THE PREFERRED EMBODIMENTS

### Methods for Making Flexographic Printing Masters

The method for making a flexographic printing master according to a preferred embodiment of the present invention includes:

a first step of providing a flexographic printing support;
a second step of applying image wise with a first resolution a layer of a radiation curable liquid partially covering the printing side of the support;
a third step of flood exposing the applied radiation curable layer to fully cure the layer; and
a fourth step of image wise laser engraving the cured layer with a second resolution which is higher than the first resolution of the second step.

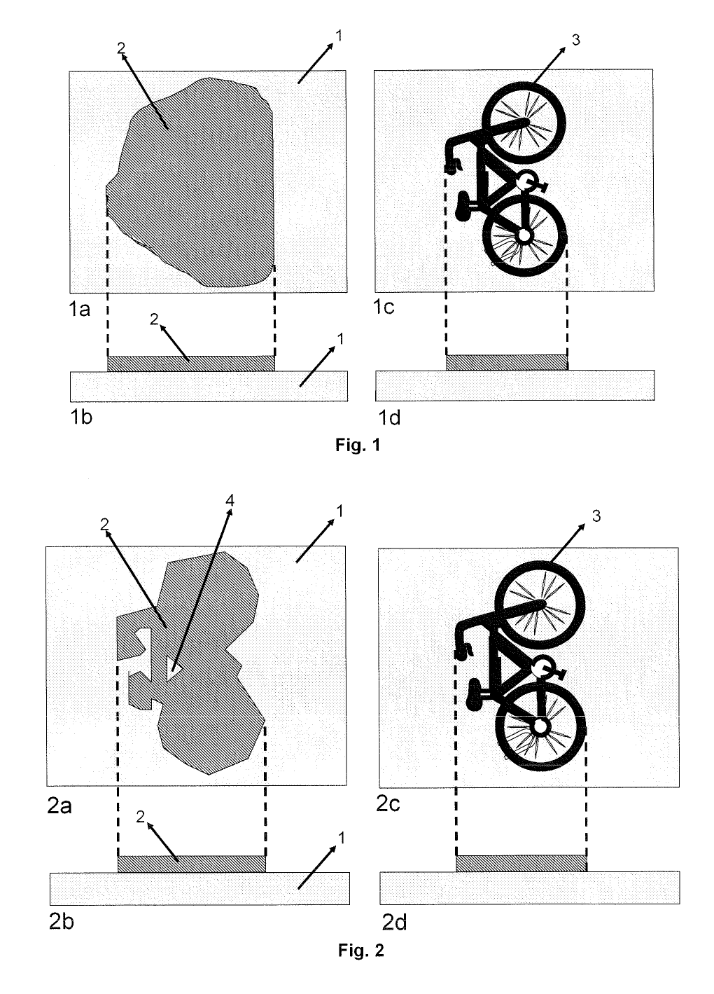

In 1a of FIG. 1, a radiation curable liquid 2 is applied by spraying onto a flexographic printing support 1. After fully curing the applied radiation curable layer an image 3 (bicycle) is laser engraved in 1b of FIG. 1.

In a preferred embodiment, the radiation curable liquid is applied in the second step by spraying or inkjet printing, more preferably by inkjet printing. If inkjet printing is used the amount of radiation curable liquid applied in the second step is minimized, which is advantageous for both reducing the production cost and for minimizing the waste and toxic substances produced by laser engraving. This is illustrated by FIG. 2. Comparison of the layer of radiation curable liquid in 1a and 1b in FIG. 1 with the layer in 2a and 2b in FIG. 2 shows that for the same image 3 less radiation curable liquid 2 is needed. Furthermore as shown by FIG. 2a, with inkjet printing it is possible to accurately not apply radiation curable liquid 2 onto the flexographic printing support 1 in the non-image area 4, which is difficult or sometimes impossible with spraying.

It should be clear that the jetted or sprayed area of radiation curable liquid 2 is larger than the size of final relief image 3.

In another preferred embodiment the second step is performed at least twice, i.e. at least a second layer of radiation curable liquid is applied onto the layer of radiation curable liquid 2 on the flexographic printing support 1. The advantage of this is that flexographic properties, such as flexibility, elongation at break and Shore A hardness, can be altered for the top part of the flexographic printing master.

In a further preferred embodiment, an intermediate curing is applied before performing the second step again.

In one preferred embodiment, the second step of jetting or spraying is performed in two, three or more different areas on the flexographic printing support which are at least 5 cm apart from each other.

The intermediate curing may be performed as a partial curing treatment, but the final curing treatment should fully cure the applied layers. The terms “partial cure” and “full cure” refer to the degree of curing, i.e. the percentage of converted functional groups, and may be determined by for example RT-FTIR (Real-Time Fourier Transform Infra-Red Spectroscopy)—a method well known to the one skilled in the art of curable formulations. A partial cure is defined as a degree of curing wherein at least 5%, preferably 10%, of the functional groups in the coated formulation is converted. A full cure is defined as a degree of curing wherein the increase in the percentage of converted functional groups, with increased exposure to radiation (time and/or dose), is negligible. A full cure corresponds with a conversion percentage that is within 10%, preferably 5%, from the maximum conversion percentage defined by the horizontal asymptote in the RT-FTIR graph (percentage conversion versus curing energy or curing time). An intermediate partial cure is advantageous for providing improved adhesion of the subsequent layer of radiation curable liquid.

In applying more than one layer of radiation curable liquid 2 onto the flexographic printing support 1 by performing the second step at least twice, different compositions of the radiation curable liquid may be used. The advantage of this is that flexographic properties, such as flexibility, elongation at break and Shore A hardness, can be altered for different parts of the relief of the flexographic printing master. The different compositions of the radiation curable liquid can be obtained as disclosed by the methods in the unpublished application PCT/EP2007/064161.

In a preferred embodiment, which can be combined with any of the above disclosed preferred embodiments, the flexographic printing support has a different colour than the cured layer of the radiation curable liquid.

In one preferred embodiment the method disclosed above is performed on a flexographic printing press.

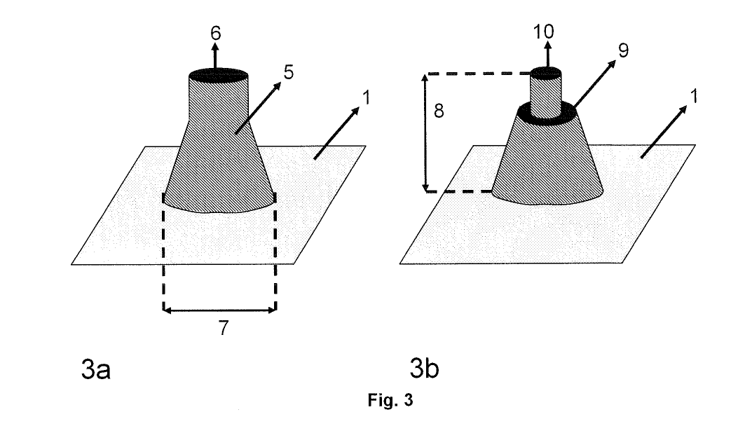

In another preferred embodiment, the relief of a flexographic printing master is created by applying multiple layers of a radiation curable liquid on a flexographic printing support by inkjet printing, as disclosed in e.g. EP 1428666 A (AGFA) and EP 1637322 A (AGFA), and similar to pencil sharpening, the resolution of the flexographic printing master made by inkjet printing is enhanced by laser engraving. This is illustrated by FIG. 3.

FIG. 3a shows a flexographic printing support 1 whereon by inkjet printing a relief 5 with a base size 7 has been created having a printing surface 6. By laser engraving the printing surface 6 can be reduced to a smaller printing surface 10 in FIG. 3b. In FIG. 3b the perimeter of the first step 9 corresponds with the perimeter of the printing surface 6 in FIG. 3a. If necessary also the relief height 8 (see FIG. 3b) can be reduced by laser engraving.

### Radiation Curable Liquids

The radiation curable liquid 2 is curable by actinic radiation which can be UV light, IR light or visible light. Preferably the radiation curable liquid is a UV curable liquid.

The radiation curable liquid preferably contains at least a photo-initiator and a polymerizable compound. The polymerizable compound can be a monofunctional or polyfunctional monomer, oligomer or pre-polymer or a combination thereof.

The radiation curable liquid may be a cationically curable liquid but is preferably a free radical curable liquid.

The free radical curable liquid preferably contains substantially acrylates rather than methacrylates for obtaining a high flexibility of the applied layer. Also the functionality of the polymerizable compound plays an important role in the flexibility of the applied layer. Preferably a substantial amount of monofunctional monomers and oligomers are used.

In a preferred embodiment of the present invention, the radiation curable liquid includes:

a) a photoinitiator; and
b) a polymerizable compound selected from the group consisting of lauryl acrylate, polyethyleneglycol diacrylate, polyethylene glycol dimethacrylate, 2-(2-ethoxyethoxy) ethyl acrylate, 2-phenoxyethyl acrylate,
2-phenoxyethyl methacrylate, propoxylated neopentylglycol diacrylate, alkoxylated hexanediol diacrylate, isobornylacrylate, isodecyl acrylate, hexane diol diacrylate, caprolacton acrylate and urethane acrylates.

In a more preferred embodiment of the present invention, the radiation curable liquid includes an aliphatic urethane acrylate. Aromatic type urethane acrylates are less preferred.

In an even more preferred embodiment, the urethane acrylate is a urethane monoacrylate. Commercial examples include GENOMER™ 1122 and EBECRYL™ 1039.

The flexibility of a given urethane acrylate can be enhanced by increasing the linear molecular weight between crosslinks. Polyether type urethane acrylates are for flexibility also more preferred than polyester type urethane acrylates.

Preferably the radiation curable liquid does not include amine modified polyether acrylates which reduce the flexibility of the cured layer.

An elastomer or a plasticizer is preferably present in the radiation curable liquid for improving desired flexographic properties such as flexibility and elongation at break.

The radiation curable liquid may contain a polymerization inhibitor to restrain polymerization by heat or actinic radiation.

The radiation curable liquid may contain at least one surfactant for controlling the spreading of the liquid.

The radiation curable liquid may further contain at least one colorant for increasing contrast of the image on the flexographic printing master.

The radiation curable liquid may further contain at least one acid functionalized monomer or oligomer.

The radiation curable liquid preferably has a viscosity at a shear rate of 100 s⁻¹ and at a temperature between 15 and 70° C. of not more than 100 mPa·s, preferably less than 50 mPa·s, and more preferably less than 15 mPa·s.

### Monofunctional Monomers

Any polymerizable monofunctional monomer commonly known in the art may be employed. Particular preferred polymerizable monofunctional monomers are disclosed in paragraphs [0054] to [0058] of EP 1637926 A (AGFA)).

Two or more monofunctional monomers can be used in combination.

The monofunctional monomer preferably has a viscosity smaller than 30 mPa·s at a shear rate of 100 s⁻¹ and at a temperature of 25° C.

### Polyfunctional Monomers and Oligomers

Any polymerizable polyfunctional monomer and oligomer commonly known in the art may be employed. Particular preferred polyfunctional monomers and oligomers are disclosed in paragraphs [0059] to [0063] of EP 1637926 A (AGFA).

Two or more polyfunctional monomers and/or oligomers can be used in combination.

The polyfunctional monomer or oligomer preferably has a viscosity larger than 50 mPa·s at a shear rate of 100 s⁻¹ and at a temperature of 25° C.

Acid functionalized Monomers and Oligomers

Any polymerizable acid functionalized monomer and oligomer commonly known in the art may be employed. Particular preferred acid functionalized monomers and oligomers are disclosed in paragraphs [0066] to [0070] of EP 1637926 A (AGFA).

### Photo-Initiators

The photo-initiator, upon absorption of actinic radiation, preferably UV-radiation, forms free radicals or cations, i.e. high-energy species inducing polymerization and crosslinking of the monomers and oligomers in the radiation curable liquid.

A preferred amount of photo-initiator is 1 to 10% by weight, more preferably 1 to 7% by weight, of the total radiation curable liquid weight.

A combination of two or more photo-initiators may be used. A photo-initiator system, comprising a photo-initiator and a co-initiator, may also be used. A suitable photo-initiator system comprises a photo-initiator, which upon absorption of actinic radiation forms free radicals by hydrogen abstraction or electron extraction from a second compound, the co-initiator. The co-initiator becomes the actual initiating free radical.

Irradiation with actinic radiation may be realized in two steps, each step using actinic radiation having a different wavelength and/or intensity. In such cases it is preferred to use 2 types of photo-initiators, chosen in function of the different actinic radiation used.

Suitable photo-initiators are disclosed in paragraphs [0077] to [0079] of EP 1637926 A (AGFA).

### Inhibitors

Suitable polymerization inhibitors include phenol type antioxidants, hindered amine light stabilizers, phosphor type antioxidants, hydroquinone monomethyl ether commonly used in (meth)acrylate monomers, and hydroquinone, methylhydroquinone, t-butylcatechol, pyrogallol may also be used. Of these, a phenol compound having a double bond in molecules derived from acrylic acid is particularly preferred due to its having a polymerization-restraining effect even when heated in a closed, oxygen-free environment. Suitable inhibitors are, for example, SUMILIZER™ GA-80, SUMILIZER™ GM and SUMILIZER™ GS produced by Sumitomo Chemical Co., Ltd.

Since excessive addition of these polymerization inhibitors will lower the sensitivity to curing of the radiation curable liquid, it is preferred that the amount capable of preventing polymerization be determined prior to blending. The amount of a polymerization inhibitor is generally between 200 and 20,000 ppm of the total radiation curable liquid weight.

### Oxygen Inhibition

Suitable combinations of compounds which decrease oxygen polymerization inhibition with radical polymerization inhibitors are: 2-benzyl-2-dimethylamino-1-(4-morpholinophenyl)-butane-1 and 1-hydroxy-cyclohexyl-phenyl-ketone; 1-hydroxy-cyclohexyl-phenyl-ketone and benzophenone; 2-methyl-1[4-(methylthio)phenyl]-2-morpholino-propane-1-on and diethylthioxanthone or isopropylthioxanthone; and benzophenone and acrylate derivatives having a tertiary amino group, and addition of tertiary amines. An amine compound is commonly employed to decrease an oxygen polymerization inhibition or to increase sensitivity. However, when an amine compound is used in combination with a high acid value compound, the storage stability at high temperature tends to be decreased. Therefore, specifically, the use of an amine compound with a high acid value compound in ink-jet printing should be avoided.

Synergist additives may be used to improve the curing quality and to diminish the influence of the oxygen inhibition. Such additives include, but are not limited to ACTILANE™ 800 and ACTILANE™ 725 available from AKZO NOBEL, EBECRYL™ P115 and EBECRYL™ 350 available from UCB CHEMICALS and CD 1012, CRAYNOR™ CN 386 (amine modified acrylate) and CRAYNOR™ CN 501 (amine modified ethoxylated trimethylolpropane triacrylate) available from CRAY VALLEY.

The content of the synergist additive is in the range of 0 to 50% by weight, preferably in the range of 5 to 35% by weight, based on the total weight of the radiation curable liquid.

### Plasticizers

Plasticizers are usually used to improve the plasticity or to reduce the hardness of adhesives, sealing compounds and coating compositions. Plasticizers are liquid or solid, generally inert organic substances of low vapour pressure.

Suitable plasticizers are disclosed in paragraphs [0086] to [0089] of EP 1637926 A (AGFA).

The amount of plasticizer is preferably at least 5% by weight, more preferably at least 10% by weight, each based on the total weight of the radiation curable liquid.

The plasticizers may have molecular weights up to 30,000 but are preferably liquids having molecular weights of less than 5,000.

### Elastomers

The elastomer may be a single binder or a mixture of various binders. The elastomeric binder is an elastomeric copolymer of a conjugated diene-type monomer and a polyene monomer having at least two non-conjugated double bonds, or an elastomeric copolymer of a conjugated diene-type monomer, a polyene monomer having at least two non-conjugated double bonds and a vinyl monomer copolymerizable with these monomers.

Preferred elastomers are disclosed in paragraphs [0092] and [0093] of EP 1637926 A (AGFA).

### Surfactants

The surfactant(s) may be anionic, cationic, non-ionic, or zwitter-ionic and are usually added in a total quantity below 20% by weight, more preferably in a total quantity below 10% by weight, each based on the total radiation curable liquid weight.

A fluorinated or silicone compound may be used as a surfactant, however, a potential drawback is bleed-out after image formation because the surfactant does not cross-link. It is therefore preferred to use a copolymerizable monomer having surface-active effects, for example, silicone-modified acrylates, silicone modified methacrylates, fluorinated acrylates, and fluorinated methacrylates.

### Colorants

Colorants may be dyes or pigments or a combination thereof. Organic and/or inorganic pigments may be used.

Suitable dyes and pigments include those disclosed by ZOLLINGER, Heinrich. Color Chemistry: Syntheses, Properties, and Applications of Organic Dyes and Pigments. Third, revised edition. WILEY-VCH, 2003. (ISBN 3906390233).

Suitable pigments are disclosed in paragraphs [0098] to [0100] of EP 1637926 A (AGFA).

The pigment is present in the range of 0.01 to 10% by weight, preferably in the range of 0.1 to 5% by weight, each based on the total weight of radiation curable liquid.

### Solvents

The radiation curable liquid preferably does not contain an evaporable component, but sometimes, it can be advantageous to incorporate an extremely small amount of a solvent to improve adhesion to the ink-receiver surface after UV curing. In this case, the added solvent may be any amount in the range of 0.1 to 10.0% by weight, preferably in the range of 0.1 to 5.0% by weight, each based on the total weight of radiation curable liquid.

### Humectants

When a solvent is used in the radiation curable liquid, a humectant may be added to prevent the clogging of the nozzle, due to its ability to slow down the evaporation rate of radiation curable liquid.

Suitable humectants are disclosed in paragraph [0105] of EP 1637926 A (AGFA).

A humectant is preferably added to the radiation curable liquid formulation in an amount of 0.01 to 20% by weight of the formulation, more preferably in an amount of 0.1 to 10% by weight of the formulation.

### Biocides

Suitable biocides include sodium dehydroacetate, 2-phenoxyethanol, sodium benzoate, sodium pyridinethion-1-oxide, ethyl p-hydroxy-benzoate and 1,2-benzisothiazolin-3-one and salts thereof. A preferred biocide for the radiation curable liquid suitable for the method for manufacturing a flexographic printing master according to a preferred embodiment of the present invention, is PROXEL™ GXL available from ZENECA COLOURS.

A biocide is preferably added in an amount of 0.001 to 3% by weight, more preferably in an amount of 0.01 to 1.00% by weight, each based on radiation curable liquid.

### Preparation of a Radiation Curable Liquid

The radiation curable liquids may be prepared as known in the art by mixing or dispersing the ingredients together, optionally followed by milling, as described for example in paragraphs [0108] and [0109] of EP 1637926 A (AGFA).

### Flexographic Printing Supports

A flexographic printing support is a support provided with or without one or more elastomeric layers, e.g. partially or fully cured layers. Preferably, the flexographic printing support comprises one or more cured layers, i.e. an “elastomeric floor”, provided on the relief forming side of the support.

The support can be any material that is conventionally used with photosensitive elements used to prepare flexographic printing masters. For good printing results, a dimensionally stable support is required.

In one preferred embodiment, the support is transparent to actinic radiation to accommodate “backflash” exposure through the support in order to form an “elastomeric floor”. The radiation curable liquid is sprayed or jetted on an uncured or a partially cured surface of the elastomeric floor, and both are cured together through which a better adhesion can be obtained. Alternatively, it is also possible to use a completely cured conventional flexographic printing form precursor as support. A wide variety of such conventional flexographic printing forms precursors are commercially available.

Examples of suitable support materials include polymeric films such as those formed by addition polymers and linear condensation polymers, transparent foams and fabrics. Under certain end-use conditions, metals such as steel, aluminium, copper and nickel may also be used as a support, even though a metal support is not transparent to radiation. The support may be in sheet form or in cylindrical form, such as a sleeve. The sleeve may be formed from single layer or multiple layers of flexible material, as for example disclosed by US 2002/0046668 (ROSSINI). Flexible sleeves made of polymeric films can be transparent to ultraviolet radiation and thereby accommodate backflash exposure for building a floor in the cylindrical printing element. Multiple layered sleeves may include an adhesive layer or tape between the layers of flexible material. Preferred is a multiple layered sleeve as disclosed in U.S. Pat. No. 5,301,610 (DU PONT). The sleeve may also be made of non-transparent, actinic radiation blocking materials, such as nickel or glass epoxy. The support typically has a thickness from 0.002 to 0.050 inch (0.0051 to 0.127 cm). A preferred thickness for the sheet form is 0.003 to 0.016 inch (0.0076 to 0.040 cm). The sleeve typically has a wall thickness from 0.1 to 1 mm for thin sleeves and from 1 to as high as 100 mm for other sleeves. The used wall thickness depends upon the application.

In another preferred embodiment the sleeve is prepared by a coating method as disclosed in WO 2008/034810 (AGFA GRAPHICS).

Preferred polymeric supports for use in the method for manufacturing a flexographic printing master according to a preferred embodiment of the present invention, are cellulose acetate propionate, cellulose acetate butyrate, polyesters such as polyethylene terephthalate (PET) and polyethylene naphthalate (PEN); oriented polystyrene (OPS); oriented nylon (ONy); polypropylene (PP), oriented polypropylene (OPP); polyvinyl chloride (PVC); and various polyamides, polycarbonates, polyimides, polyolefins, poly(vinylacetals), polyethers and polysulfonamides, opaque white polyesters and extrusion blends of polyethylene terephthalate and polypropylene. Acrylic resins, phenol resins, glass and metals may also be used as an ink-receiver. Other suitable supports can be found in Modern Approaches to Wettability: Theory and Applications. Edited by SCHRADER, Malcolm E., et al. New York: Plenum Press, 1992. ISBN 0306439859.

Different types of printing applications require flexographic printing forms with differing degrees of hardness. Softer flexographic printing forms are more suited for rough supports because they can better cover the highs and lows. The harder flexographic printing forms are used for even and smooth supports. The optimum hardness of a flexographic printing form also depends on whether the image is solid or halftone. Softer flexographic printing forms will transfer the ink better in solid areas, though harder flexographic printing forms have less dot gain. In an image composed of solid areas and halftone areas, inkjet printing allows the printing of different mixtures of two or more inkjet fluids on the solid and the halftone areas which is an advantage not attainable by a traditional flexographic printing form. Thus a flexographic printing form having a hardness which differs by at least 5° Shore A in two different surface areas of the flexographic printing form can be made.

Depending on the support being printed, the hardness and thickness of the flexographic printing form have to be adjusted. Depending on the application, the relief depth varies from 0.2 to 4 mm, preferably from 0.4 to 2 mm.

The hardness is a measure of the printing form's mechanical properties which is measured in degree of Shore A. For example, printing on corrugated board requires usually a hardness of 35° Shore A, whereas for reel presses 65° Shore A is a standard.

### Imaging Apparatuses

An imaging apparatus for making a flexographic printing master according to a preferred embodiment of the present invention includes a device for spraying or inkjet printing a radiation curable liquid, a device for curing a radiation curable liquid and a device for directly laser engraving the radiation curable liquid.

The imaging apparatus preferably has a drum for holding the flexographic printing support, which is preferably a sleeve.

The imaging apparatus preferably has a recording drum rotatable with a flexographic printing support mounted peripherally thereof, a spraying device or inkjet printing head movable parallel to the axis of this recording drum, and a device for generating a laser engraving beam movable parallel to the axis of this recording drum. The laser beam from a laser generator typically passes through an acoustic-optic modulator (AOM) before it passes through a focusing lens. Both the AOM and the movement of the flexographic printing support are digitally controlled, thus creating an image from the cured layer of radiation curable liquid on the flexographic printing support directly from a digital file; the focused laser beam ablates material from the cured layer, which can be collected by an extraction system. The flexographic printing master is then press-ready, optionally after a short water-wash and drying step.

In one preferred embodiment the imaging apparatus is mounted on a flexographic printing press.

### Device for Spraying or Inkjet Printing

The device for spraying includes any device capable of coating a surface by breaking up a radiation curable liquid into small droplets which are then directed, possibly with the help of a current of air or an electrostatic charge, onto the surface. These devices include spray guns and spray heads.

However in the most preferred embodiment the radiation curable liquids are jetted by one or more printing heads ejecting small droplets in a controlled manner through nozzles onto a flexographic printing support, which is moving relative to the printing head(s).

A preferred printing head for the inkjet printing system is a piezoelectric head. Piezoelectric inkjet printing is based on the movement of a piezoelectric ceramic transducer when a voltage is applied thereto. The application of a voltage changes the shape of the piezoelectric ceramic transducer in the printing head creating a void, which is then filled with radiation curable liquid. When the voltage is again removed, the ceramic expands to its original shape, ejecting a drop of liquid from the print head. However the inkjet printing method is not restricted to piezoelectric inkjet printing. Other inkjet printing heads can be used and include various types, such as a continuous type and thermal, electrostatic and acoustic drop on demand type.

At high printing speeds, the radiation curable liquids must be ejected readily from the printing heads, which puts a number of constraints on the physical properties of the liquid, e.g. a low viscosity at the jetting temperature, which may vary from 25° C. to 110° C., a surface energy such that the printing head nozzle can form the necessary small droplets, a homogenous radiation curable liquid capable of rapid conversion to a dry printed area, . . . .

The inkjet printing head normally scans back and forth in a transversal direction across the moving flexographic printing support. The inkjet print head does not need to print on the way back, but bi-directional printing is preferred for reasons of productivity. Another preferred printing method is by a “single pass printing process”, which can be performed by using page wide inkjet printing heads or multiple staggered inkjet printing heads which cover the entire width of the flexographic printing support. In a single pass printing process, the inkjet printing heads usually remain stationary and the flexographic printing support is transported under the inkjet printing heads, e.g. by the recording drum described above.

### Device for Direct Laser Engraving

Direct laser engraving means direct ablation of the non-printing areas from a cured layer on a flexographic plate or sleeve.

The laser used in the laser engraving can be any laser as long as it is able to form a pattern by laser ablation of the pattern-forming material. In order to carry out the engraving with high speed, a laser having a high power is desirable. One preferable example of the laser is a laser having an emitting wavelength in an infrared region or near infrared region, for example, a carbon dioxide gas laser, a YAG laser, a semiconductor laser or a fiber laser. Also, an ultraviolet laser having an emitting wavelength in an ultraviolet region, for example, an excimer laser, a YAG laser wavelength-converted to the third harmonic or the fourth harmonic or a copper vapor laser is also able to conduct ablation processing which cleaves a bond between molecules of organic compound and thus is suitable for microfabrication. A laser having an extremely high peak power, for example, a femtosecond laser can also be employed. The laser irradiation may be performed continuously or pulsewise. As for the flexographic printing plate precursor for laser engraving, a carbon dioxide gas laser or a YAG laser is preferably used.

Although the engraving with laser is conducted under oxygen-containing gas, ordinarily in the presence of air or in airflow, it can be conducted under carbon dioxide gas or nitrogen gas. After the completion of the engraving, the powdery or liquid substance (scrap) occurred on the surface of relief image can be removed by an appropriate method, for example, a method of washing out, for example, with a solvent or water containing a surfactant, a method of spraying an aqueous cleaning agent, for example, by a high-pressure sprayer, a method of spraying high-pressure steam, or a method of wiping off with cloth or the like.

Preferred lasers for laser engraving include CO₂-lasers and Nd-YAG lasers. For example, a Stork Agrios triple beam CO₂-laser can be used. Fiber lasers can also be used if, for example, a carbon black pigment is present in the radiation curable liquid.

Suitable devices for laser engraving are disclosed in EP 1700691 A (DAINIPPON SCREEN) incorporated herein as reference.

### Devices for Curing Radiation Curable Liquids

The imaging apparatus contains a device for curing a radiation curable liquid. Radiation curable liquids are cured by exposing them to actinic radiation, e.g. by UV curing, by thermal curing and/or by electron beam curing. Preferably the curing is performed by UV radiation.

The curing device may be arranged in combination with the inkjet print head, travelling therewith so that the curable liquid is exposed to curing radiation very shortly after been jetted.

In such an arrangement it can be difficult to provide a small enough radiation source connected to and travelling with the print head. Therefore, a static fixed radiation source may be employed, e.g. a source of curing UV-light, connected to the radiation source by a flexible radiation conductor such as a fibre optic bundle or an internally reflective flexible tube.

Alternatively, the actinic radiation may be supplied from a fixed source to the radiation head by an arrangement of mirrors including a mirror upon the radiation head.

The source of radiation arranged not to move with the print head, may also be an elongated radiation source extending transversely across the flexographic printing support surface to be cured and adjacent the transverse path of the print head so that the subsequent rows of images formed by the print head are passed, stepwise or continually, beneath that radiation source.

Any ultraviolet light source, as long as part of the emitted light can be absorbed by the photo-initiator or photo-initiator system, may be employed as a radiation source, such as, a high or low pressure mercury lamp, a cold cathode tube, a black light, an ultraviolet LED, an ultraviolet laser, and a flash light.

For curing the sprayed or inkjet printed radiation curable liquid, the imaging apparatus preferably has a plurality of UV light emitting diodes. The advantage of using UV LEDs is that it allows a more compact design of the imaging apparatus.

For facilitating curing, the imaging apparatus preferably includes one or more oxygen depletion units. The oxygen depletion units place a blanket of nitrogen or other relatively inert gas (e.g. CO₂), with adjustable position and adjustable inert gas concentration, in order to reduce the oxygen concentration in the curing environment. Residual oxygen levels are usually maintained as low as 200 ppm, but are generally in the range of 200 ppm to 1200 ppm.

Thermal curing can be performed image-wise e.g. by use of a thermal head or a laser beam. If a laser beam is used, then preferably an infrared laser is used in combination with an infrared dye in the curable liquid.

When electron beams are employed, the exposure amount of the electron beam is preferably controlled to be in the range of 0.1-20 Mrad. An exposure amount of less than 0.1 Mrad does not result in sufficient curing of the curable liquids. Accepted as electron beam exposure systems are, for example, a scanning system, a curtain beam system, and a broad beam system. An appropriate acceleration voltage during electron beam exposure is preferably 100-300 kV.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-15. (canceled)

16. A method for making a flexographic printing master comprising:
a first step of providing a flexographic printing support;
a second step of applying image-wise, at a first resolution, a layer of a radiation curable liquid partially covering a printing side of the flexographic printing support;
a third step of flood exposing the layer of radiation curable liquid to fully cure the layer of the radiation curable liquid; and
a fourth step of image-wise laser engraving the cured layer of the radiation curable liquid at a second resolution which is higher than the first resolution.

17. The method according to claim 16, wherein the radiation curable liquid is applied in the second step by spraying or inkjet printing.

18. The method according to claim 16, wherein the flexographic printing support includes an elastomeric floor.

19. The method according to claim 17, wherein the flexographic printing support includes an elastomeric floor.

20. The method according to claim 16, wherein the flexographic printing support is a sleeve.

21. The method according to claim 17, wherein the flexographic printing support is a sleeve.

22. The method according to claim 19, wherein the flexographic printing support is a sleeve.

23. The method according to claim 16, wherein the second step is performed at least twice.

24. The method according to claim 17, wherein the second step is performed at least twice.

25. The method according to claim 23, wherein different compositions of the radiation curable liquid are used when performing the second step at least twice.

26. The method according to claim 24, wherein different compositions of the radiation curable liquid are used when performing the second step at least twice.

27. The method according to claim 23, further comprising an intermediate step of curing the radiation curable liquid before performing the second step again.

28. The method according to claim 24, further comprising an intermediate step of curing the radiation curable liquid before performing the second step again.

29. The method according to claim 25, further comprising an intermediate step of curing the radiation curable liquid before performing the second step again.

30. The method according to claim 26, further comprising an intermediate step of curing the radiation curable liquid before performing the second step again.

31. The method according to claim 16, wherein the flexographic printing support has a different color than the cured layer of the radiation curable liquid.

32. The method according to claim 17, wherein the flexographic printing support has a different color than the cured layer of the radiation curable liquid.

33. The method according to claim 16, wherein the first through fourth steps are performed on a flexographic printing press.

34. The method according to claim 17, wherein the first through fourth steps are performed on a flexographic printing press.

35. An imaging apparatus for making a flexographic printing master, the apparatus comprising:
a device to image-wise spray or inkjet print a radiation curable liquid onto a flexographic printing support;
a device to cure the radiation curable liquid; and
a device to image-wise laser engrave the cured radiation curable liquid.

36. The imaging apparatus according to claim 35, further comprising a drum arranged to hold the flexographic printing support.

37. The imaging apparatus according to claim 35, wherein the device to cure the radiation curable liquid includes a plurality of UV light emitting diodes.

38. The imaging apparatus according to claim 35, further comprising an oxygen depletion unit.

39. A flexographic printing press comprising:
the imaging apparatus according to claim 35.

40. A method of enhancing a resolution of a flexographic printing master comprising the steps of:
image-wise inkjet printing a radiation curable liquid on a flexographic printing support to produce a flexographic printing master; and
image-wise laser engraving the radiation curable liquid.
